(19) United States
(12) Patent Application Publication
(10) Pub. No.: US 2025/0206509 A1
(43) Pub. Date: Jun. 26, 2025

(54) A BARRIER FILM FOR A PACKAGING MATERIAL AND A PACKAGING MATERIAL

(71) Applicant: Stora Enso OYJ, Helsinki (FI)

(72) Inventors: Åsa Nyflött, Karlstad (SE); Gisela Cunha, Nacka (SE); Kaj Backfolk, Lappeenranta (FI); Tommi Nordström, Turku (FI)

(73) Assignee: Stora Enso OYJ, Helsinki (FI)

(21) Appl. No.: 18/874,636

(22) PCT Filed: Jun. 19, 2023
(86) PCT No.: PCT/IB2023/056309

§ 371 Date: Dec. 13, 2024

(30) Foreign Application Priority Data
Jun. 23, 2022 (SE) 2230206-01

(51) Int. Cl. B65D 65/42; D21H 19/08; D21H 19/84

(52) U.S. Cl. CPC B65D 65/42; D21H 19/08; D21H 19/84

(57) ABSTRACT

A barrier film (1) for a paper or paperboard-based packaging material, said barrier film comprising a, MFC layer, (2) with a grammage in the range 20-100 g/m2, and a density higher than 650 kg/m3. The barrier film further comprises a PHA, dispersion coated, primer layer (3, 9) coated on at least one side of the MFC layer, wherein the primer layer has a coating weight 0.5-12 g/m2; the primer layer (3, 9) comprises a PHA type selected from the group consisting of PHB, PHBV, PHBH, P(3HB4HB), other co-polymers of PHB, other homopolymers such as PHO, PHH, P3HP, and combinations thereof; and a thin vacuum deposited layer (4) coated on a first primer layer (3) which vacuum deposited layer has a thickness of 20-500 nm, the vacuum deposited layer comprises material selected from the group consisting of aluminum, magnesium, silicon, copper, aluminum oxides, magnesium oxides, silicon oxides and combinations thereof, preferably aluminum oxides.

### TECHNICAL FIELD

The present invention relates to a barrier film for a paper or paperboard-based packaging material, said barrier film comprising a microfibrillated cellulose layer, MFC layer, with a first side and a second side, it has a grammage in the range 20-100, preferably 20-50 g/m², and a density higher than 650 kg/m³.

The invention also relates to a paper or paperboard-based packaging material comprises a paper or paperboard substrate with a first side, so called print side, and a second side which faces away from the first side.

### Background-Problem

Packaging materials for food and liquids including aseptic packages in ambient distribution, chilled distribution, or hot filled products, play an important role in the protection of the packed content. The packages should not only prolong shelf time of the packed content, but also offer a laminate or packaging structure which enables reuse and recycling.

Fibre-based materials represents a renewable source and sustainable alternative to fossil based or plastic based packaging. Fibre-based substrates such as paper or paperboard are usually extrusion or dispersion coated and/or laminated with thin polymer layers to provide barrier properties as for providing other functions such as sealing properties.

For more demanding applications, aluminium foil has been used in the laminates to provide barrier properties against particularly aroma, light, and water vapor and gases.

To offer the market more sustainable solutions, there is a need to find aluminium foil free solution, but also laminate structure which are more sustainable in terms of recycling, reuse and/or compostability.

One technical solution disclosed in the prior art presents the use of paper-based solutions, especially high-density paper grades such as greaseproof paper or parchment paper, for carrier substrate for vacuum deposited organic or inorganic materials.

These barrier papers are then laminated to paperboard using a tie layer. A typical structure is PE/board/tie layer/barrier paper/metallization layer/PE. In some cases, the tie layer (PE) has been replaced by a water-soluble polymer layer such as polysaccharide or polyvinyl alcohol. Another laminate structure is a barrier paper with, for example a PVOH coating, or modified analogies or recipes thereof, prior to vacuum coating or metallization.

A problem is that the PVOH, when used as pre-coating or tie layer, may increase the risk with delamination when subjecting to high relative humidity or if moisture diffusion occurs such as in sterilization allowing the PVOH to dissolve. Another problem is that upon compostability of the aforementioned structures metals from the metallization layer are leached to the soil, and over time can lead to serious environmental problem.

### OBJECT OF THE INVENTION

An object with the invention is to provide a barrier film with good barrier properties and which is recyclable and reusable.

Another object is to provide a retortable barrier film and laminate for which recyclability is improved and especially pre- and post-consumer recyclability.

Yet another object is to provide a barrier film which solves, or at least reduces, the above-mentioned problems.

### SUMMARY OF THE INVENTION

In accordance with the invention the inventive barrier film is characterized in that the film further comprises—a PHA, dispersion coated, primer layer coated on at least one side of the MFC layer, wherein the primer layer has a coat weight 0.5-12 g/m², preferably 1-8 g/m², the primer layer comprises a PHA type selected from the group consisting of PHB, PHBV, PHBH, P(3HB4HB), other co-polymers of PHB, other homopolymers such as PHO, PHH, P3HP, and combinations thereof; and—a thin vacuum deposited layer coated on a first primer layer which vacuum deposited layer has a thickness of 20-500 nm, preferably 20-200 nm, the vacuum deposited layer comprises material selected from the group consisting of aluminum, magnesium, silicon, copper, aluminum oxides, magnesium oxides, silicon oxides and combinations thereof, preferably aluminum oxides.

The paper or paperboard-based packaging material is characterized in that further comprises:
a PHA adhesive layer coated on the second side of the substrate; and
the above-mentioned barrier film, wherein the barrier film is attached to the substrate via the adhesive layer.

### Definitions

### Microfibrillated Cellulose (MFC)

Microfibrillated cellulose (MFC) shall in the context of the patent application refer to a cellulose particle, fiber or fibril having a width or diameter of from 4 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicelluloses or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

A preferred grade that can be used is a refined cellulose fiber composition, wherein the refined cellulose fiber composition has a Schopper-Riegler (SR) number in the range >80 as determined by standard ISO 5267-1, and wherein the refined cellulose fiber composition has a content of fibers having a length >0.2 mm of at least 12 million fibers per gram based on dry weight.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled substrate.

Thin barrier substrates made from cellulose such as barrier comprising MFC or for example highly refined pulp, can be efficient barrier materials in packaging or in various laminate structures.

### Polyhydroxyalkanoate (PHA)

PHAs or polyhydroxyalkanoates shall in the context of the patent application refer to a biopolyester family that has a variety of structures and that are synthesized by a broad range of natural and genetically engineered bacteria and genetically engineered plant crops. PHAS can be synthesized in a wide range of environmental conditions and media by 30% of bacteria that live in soil. The bacteria produce PHAs by fermentation of sugar or lipids with the aim to store carbon and energy. Examples of bacterial strains that can produce PHAS include Alcaligenes eutrophus, Alcaligenes latus, Azotobacter, Aeromonas, Comamonas, Pseudomonads, and other genetically engineered organisms, such as genetically engineered microbes like Pseudomonas, Ralstonia and Escherichia coli. In general, PHAs are formed by enzymatic polymerization of one or more monomer units inside living bacteria or plant cell. Over 100 different types of monomers have been identified and incorporated into the PHA polymers, including 3-hydroxybutanoic acid and 3-hydroxypentanoic acid. PHAs can be classified into homopolymers, such as the well-known polyhydroxybutyrate (PHB), or co-polymers like poly(3-hydroxybutyrate-co-3-hydroxyvalerate) (PHBV). Additionally, depending on the size of the carbon chain, they are further categorized into short chain length (SCL), medium chain length (MCL) or long chain length (LCL) PHAS. Since they constitute a broad family of biodegradable polymers, PHAs display very versatile properties that can benefit many different industrial applications, including cosmetics, biomedicine and packaging, to name a few.

### DESCRIPTION OF THE INVENTION

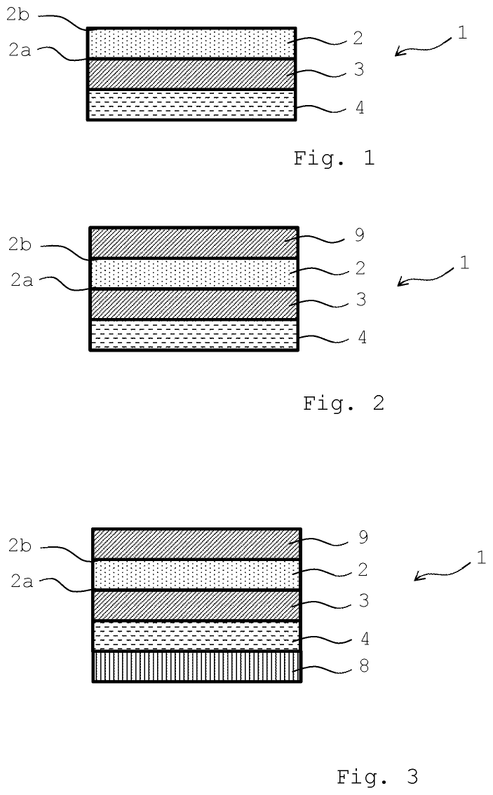

In the following, the invention will be described further with reference to FIGS. 1-6. Note that the drawings in FIGS. 1-6 are schematical and not to scale.

FIG. 1 shows a first embodiment of a barrier film.

FIG. 2 shows a second embodiment of a barrier film.

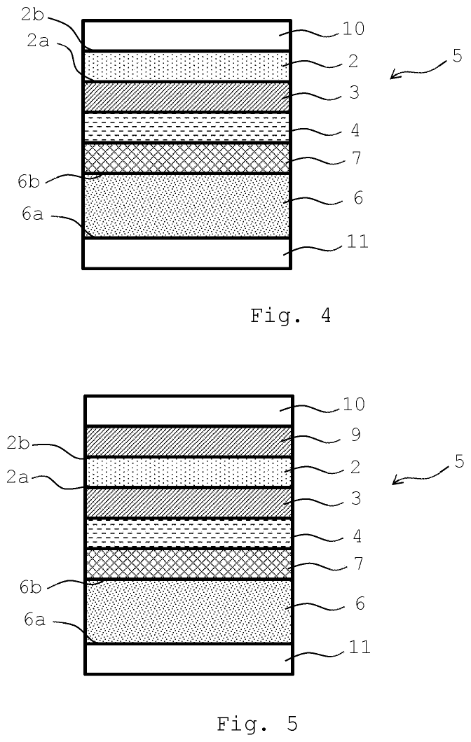

FIG. 3 shows a third embodiment of a barrier film.

FIG. 4 shows a first embodiment of a paper or paperboard-based packaging material comprising a barrier film.

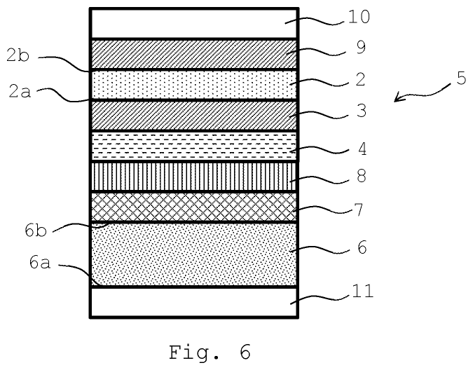

FIG. 5 shows second embodiment of a paper or paperboard-based packaging material comprising a barrier film.

FIG. 6 shows third embodiment of a paper or paperboard-based packaging material comprising a barrier film.

### Barrier Film

A barrier film 1 for a paper or paperboard-based packaging material, will be described more in detail.

### MFC Layer

The barrier film 1 comprising a microfibrillated cellulose layer 2 (MFC layer). The MFC layer 2 has a first side 2a and a second side 2b which faces away from the first side 2a. The MFC layer 2 has a grammage in the range 20-100, preferably 20-50 g/m², and a density, determined with ISO 534, in the range 650-1400 kg/m³. The MFC of the MFC layer of the inventive barrier film may be unmodified MFC or chemically modified MFC, or a mixture thereof. The MFC layer may further contain fillers. The MFC layer contains at least 50% MFC such as 60-100% or 70-98% based on total organic content determined by residue of ignition of cellulosic material according to ISO 1762:2015.

In a preferred embodiment, at least the first side 2a of the MFC layer 2 has a surface roughness, Parker Print-Surf (PPS), in the range 0.5-5.5 μm, preferably 0.8-5 μm according to ISO 8791-4, measured with a clamping pressure of 1.0 MPa.

Preferably, the MFC layer 2 has a water absorption value, COBB 60, determined according to SCAN-P 12:64, lower than 50 g/m² preferably lower than 45 g/m², more preferred 10-40 g/m² and most preferred 15-35 g/m².

The air resistance of the MFC layer 2, measured with Gurley-Hill ISO 5636-5:2013, is higher than 5000 s/100 ml, preferably higher than 20000 s/100 ml and most preferred 000-42 300 s/100 ml. 42 300 s/100 ml is the maximum value for the apparatus (Gurley-Hill).

Also, the MFC contains 0-50% of unrefined or gentle refined fibres such that hardwood or softwood fibres have a Schopper-Riegler (SR) value between 12-50 preferably 20-45. This fraction might be important to ensure mechanical strength during dispersion coating of PHA (see below). Alternatively, the MFC layer can be simply composed of highly refined cellulose-so called coarse MFC grade, which is easier to dewater than the conventional fine MFC grade. This grade in combination with PHA coating gives a surprisingly good barrier.

MFC layer can be a free-standing film made with papermaking technology, or by using cast forming on non-porous substrate.

One option is that the MFC layers is deposited on a fiber web such as with wet-on-wet principle, this forming a MFC layer on a fiber-based base substrate.

### PHA Primer Layer

The barrier film 1 further comprising at least one PHA dispersion coating primer layer 3, 9. FIG. 1 discloses a first embodiment of the barrier film, wherein the first side 2a of the MFC layer is coated with a first primer layer 3. FIG. 2 discloses a preferred second embodiment and FIG. 3 discloses a preferred third embodiment of the barrier film 1 where the first side 2a of the MFC layer 2 is coated with a first primer layer 3 and the second side 2b of the MFC layer 2 is coated with a second primer layer 9. The primer layer 3, 9 has a coating weight of 0.5-12 g/m², preferably 1-8 g/m².

The PHA dispersion coated MFC layer should also be pinhole free.

Preferably the dispersion coated MFC layer, i.e. the MFC layer and the dispersion coated PHA primer coating, comprises less than 10 pinholes/m², preferably less than 8 pinholes/m², and more preferably less than 2 pinholes/m², as measured according to standard EN13676:2001

The primer layer 3, 9 comprises a PHA type selected from the group consisting of PHB, PHBV, PHBH, P(3HB4HB), other co-polymers of PHB, other homopolymers such as PHO, PHH, P3HP, and combinations thereof.

The PHA primer layer 3, 9 is thermal stable, i.e. it has a relative high melting temperature (Tm). The measured melting temperature (Tm), according to ISO 11357-3:2018, is in the range 50-180° C., preferably 60-150° C. and most preferred 100-140° C.

Moreover, co-polymers of PHB comprising 0-40 mol %, preferably 2-30 mol %, more preferably 5-25 mol % of specific functional group (e.g., valerate, hexanoate) or change in the backbone (e.g., alternating 3HB and 4HB) for flexibility. Whereas homopolymers other than PHB are flexible by nature.

The PHA dispersion layer 3, 9 comprises stabilizers (e.g., PVOH, EVOH, PVAc, cellulose derivates, polysaccharides), fillers (e.g., clays, calcium carbonate, talc, kaolinite, montmorillonite, bentonite, silica, chitin, titanium dioxide, nano clay, nanocellulose, or mixtures thereof.), nucleating agents (e.g., talc, mica, boron nitride, crystalline nanocellulose, sodium benzoate, calcium carbonate, silica, ionomers, clay, diacetal, titanium oxide, dibenzylidene sorbitol, benzophenone, diacetal benzoate, lithium benzoate, sodium benzoate, potassium benzoate, thymine, sodium organophosphate).

The PHA dispersion layer 3, 9 may also comprise: Surfactants: cationic, anionic, non-ionic, and amphoteric surfactants—e.g., polysorbates, aromatic polyethylene oxides, sorbitan derivatives, block copolymers of poly(ethylene oxide) and poly(propylene oxide), poly(glycol ethers), alkyl sulfates, alkyl phosphates, stearates saponins.

Defoamers: polyether siloxanes, silicones, stereates, glycols, vegetable oils.

Plasticizers: glycerol, sorbitol, mannitol, xylitol, ethylene glycol, fatty acids, monosaccharides, urea, vegetable oils.

The solid content of PHA dispersion is >20 wt %, preferably >35 wt % and most preferred 45-60 wt %.

According to the TAPPI test method T 701 pm-01, the dispersion has a water retention value below 150 g/m², preferably less than 140 g/m² and most preferred 20-130 g/m².

The content of PHA in the primer layer 3, 9 is at least 40%.

The primer layer 3,9 may contain pigments/fillers up to 40 wt %, which in turn have a great impact, i.e. better blocking effect on UV transparency and light transmission.

After the first PHA primer layer 3 has been coated on the first side 2a of the MFC layer 2, the first side 2a has a surface roughness, Parker Print-Surf (PPS), in the range 0.5-4 μm, according to ISO 8791-4, measured with a clamping pressure of 1.0 MPa.

The primer layer 3, 9 also gives a barrier effect, especially improved KIT value, which is surprising. It also reduces MOAH/MOSH migration and enable use of recycled fibre in board.

The primer layer 3, 9 may be single, double, or triple coated. After each coating layer, the primer layer 3, 9 is dried. The surface temperature of the substrate during drying reaches a max temperature above 80° C., preferably above 85° C. and most preferred above 88° C. The moisture content after drying the substrate is below 6 wt %, preferably 1-5 wt %

The PHA purity (before addition of additives) is >98 wt %, preferably >99 wt %, most preferred >99.8 wt % (typically impurities are fragments of bacteria cell wall, which can include proteins)

PTS recyclability for the barrier film is high i.e. providing less than 20% reject when made according to the PTS repulpability standard RH 021-97.

The surface energy of PHA primer layer 3, 9, when applied (and dried) on the MFC layer 2, is 30-70 mN/m, preferably 35-70 mN/m and most preferred 40-65 mN/m according to ISO 19403-2.

### Thin Vacuum Deposited Layer

The barrier substrate 1 further comprises a thin vacuum deposited layer 4, obtained by vacuum deposition, i.e., deposition of a metal or a non-metal or an oxide thereof. The vacuum deposited layer 4 is coated on the first primer layer 3. The vacuum deposited layer 4, on the first primer layer 3, has a thickness of 20-500 nm, preferably 20-200 nm.

The vacuum deposited layer 4 comprises material selected from the group consisting of aluminum, magnesium, silicon, copper, aluminum oxides, magnesium oxides, silicon oxides and combinations thereof, preferably aluminum oxides.

After vacuum coating, the opposite side of the MFC layer 2 might need to be re-moisturized for adjusting moisture content to 1-5 wt %.

In an alternative embodiment, the outer surface of the first primer coating layer can be treated with corona, plasma or flame prior to the vacuum deposited surface layer 4. The mentioned treatments further pre-activate the primer coating, thus giving better performance for the whole structure.

Example of technologies for applying the thin vacuum deposition layer: plasma enhanced chemical vapor deposition (PECVD), atomic layer deposition (ALD), conventional metallization, CCVD or PECVD, or as is otherwise known in the art. In certain embodiments, the alumina and/or silica layer is deposited via CCVD or PECVD at open atmosphere. Other methods are sputtering, chemical vapor deposition (CVD), combustion chemical vapor deposition (CCVD), physical vapor deposition (PVD), plasma enhanced chemical vapor deposition (PECVD), vacuum deposition, flame deposition, and flame hydrolysis deposition.

### PHA Protection Layer

FIG. 3 discloses a preferred third embodiment of the barrier film, wherein the vacuum deposited layer 4 is protected by a PHA protective layer 8. The protective layer has a coat weight of 0.5-20 g/m².

The PHA type in the protective layer 8 is selected from the group consisting of PHB, PHBV, PHBH, P(3HB4HB), and combinations thereof.

The protective layer has a melting temperature (Tm) in the range 100-180° C., preferably 120-170° C. and most preferred 130-160° C.

The content of PHA in the protection layer 8 is at least 70%.

The protection layer 8 could be applied by either extrusion coating, lamination or dispersion coating, in one or several steps.

The barrier film 1 has an oxygen transmission rate (OTR): <10 mL/m²/day, preferably <5 mL/m²/day and most preferred <2 mL/m²/day at 23° C. and 50% RH according to ASTM F1927-20.

The barrier film 1 has an oxygen transmission rate (OTR): <30 mL/m²/day, preferably <20 mL/m²/day and most preferred <10 mL/m²/day at 38° C. and 90% RH according to ASTM F1927-20.

The barrier film 1 has a water vapor transmission rate (WVTR): <5 g/m²/day, preferably <2 g/m²/day and most preferred <1 g/m²/day, at 23° C. and 50% RH according to ASTM F1249-20

The barrier film 1 has a water vapor transmission rate (WVTR): <20 g/m²/day, preferably <15 g/m²/day and most preferred <10 g/m²/day at 38° C. and 90% RH according to ASTM F1249-20

### Packaging Material

The invention also covers a packaging material 5 comprising a paper or paperboard substrate 6 and the inventive barrier film 1.

### First Embodiment

FIG. 4 discloses a first embodiment of the packaging material 5.

The packaging material 5 comprising a paper or paperboard-based substrate 6. The substrate 6 has a first side 6a, so called print side, and a second side 6b which faces away from the first side 6a. A PHA adhesive layer 7 is deposited on the second side 6b of the substrate 6.

The packaging material further comprising the barrier film 1, wherein only the first side 2a of the MFC layer 2 is coated with the primer layer 3.

The barrier film 1 is attached to the substrate 6 via the adhesive layer 7. In addition, the adhesive layer 7 can also protect the vacuum deposited layer 4. The adhesive layer activating the surface on the barrier film 1 as well as substrate 6 and create hydrogen/covalent/van der Waals bonding between the layers.

FIG. 4 discloses a preferred embodiment where the second side 2a of the MFC layer 2 faces against the substrate 6.

The second side 2b of the MFC layer 2 is preferably sealed with an inner, liquid barrier layer 10 and the first side 6a of the substrate 6 is preferably sealed with an outer, decor layer 11. These layers 10, 11 can be either single or multiply layers. E.g., each layer 10, 11 may be a two co-extruded PHA layers.

In an alternative embodiment (not showed in Figures) the second side 2b of the MFC layer 2 is facing against the substrate 6.

### Second Embodiment

FIG. 5 disclosing a second embodiment of the packaging material 5.

The packaging material comprising a paper or paperboard-based substrate 6. The substrate 6 has a first side 6a, so called print side, and a second side 6b which faces away from the first side 6a. A PHA adhesive layer 7 is deposited on the second side 6b of the substrate 6.

The packaging material further comprising the inventive barrier film 1, wherein the first side 2a of the MFC layer 2 is coated with the first primer layer 3 and the second side 2b of the MFC layer 2 is coated with the second primer layer 9.

The barrier film 1 is attached to the substrate 6 via the adhesive layer 7. In addition, the adhesive layer 7 can also protect the vacuum deposited layer 4.

FIG. 5 discloses a preferred embodiment where the second side 2a of the MFC layer 2 faces against the substrate 6.

The second primer layer 9 is preferably sealed with an inner, liquid barrier layer 10 and the first side 6a of the substrate 6 is preferably sealed with an outer, decor layer 11. These layers 10, 11 can be either single or multiply layers. E.g., each layer 10, 11 may be a two co-extruded PHA layers

In an alternative embodiment (not showed in Figures) the second side 2b of the MFC layer 2 is facing against the substrate 6.

### Third Embodiment

FIG. 6 disclosing a third embodiment of the packaging material 5.

The packaging material comprising a paper or paperboard-based substrate 6. The substrate 6 has a first side 6a, so called print side, and a second side 6b which faces away from the first side 6a. A PHA adhesive layer 7 is deposited on the second side 6b of the substrate 6.

The packaging material further comprising the barrier film 1, wherein the first side 2a of the MFC layer 2 is coated with a first primer layer 3 and the second side 2b of the MFC layer 2 is coated with a second primer layer 9. The first primer layer 3 is coated with a vacuum deposition layer 4.

The barrier film 1 is attached to the second side 6b of the substrate 6 via the adhesive layer 7. In addition, the adhesive layer 7 can also protect the vacuum deposited layer 4.

FIG. 6 discloses a preferred embodiment where the second side 2a of the MFC layer 2 faces against the substrate 6.

The second side 2b of the MFC layer 2 is preferably sealed with an inner, liquid barrier layer 10 and the first side 6a of the substrate 6 is preferably sealed with an outer, decor layer 11. These layers 10, 11 can be either single or multiply layers, e.g., each layer 10, 11 may be a two co-extruded PHA layers

In an alternative embodiment (not showed in Figures) the second side 2b of the MFC layer 2 is facing against the substrate 6.

A great benefit with the inventive barrier film is that it is retortable, in comparison to barrier films using water soluble tie layers.

Another benefit with the invention is that broke from the prime coated MFC layer, i.e., MFC layer 2 and PHA dispersion coating layer 3, 9 can be disintegrated and reused in an amount of 0-60 wt % when making a new MFC layer 2. Such MFC layer 2 could possibly contain 0-50 wt % uncoated broke (no PHA dispersion primer), 0-50 wt % coated broke (with PHA dispersion primer), 0-50 wt % unrefined or gentle refined pulp and >50 wt % MFC or highly refined pulp.

Example 1 of a furnish composition:
10 wt % uncoated broke
10 wt % coated broke
10 wt % pulp, refined to Schopper-Riegler, SR 25
70 wt % MFC pulp, refined to SR 92

Example 2 of a furnish composition:
15 wt % coated broke
5 wt % pulp, refined to SR 25
80 wt % MFC pulp, refined to SR 92

The invention discloses a packaging material designed aseptic packaging and for shelf-life extending heat treatment at elevated temperature for example with steam as the heat medium. Examples of such shelf-life extending heat treatments are hot fill with subsequent pasteurization or retort and steam autoclave treatments.

The treatment is normally carried out at temperatures higher than 80° C. The heat treatment may for example co-sterilize the package and package content, such as food products.

The heat treatment can be carried out at an overpressure and a temperature above 100° C., such as above 110 or 121° C., such as 121-140° C.

An alternative heat treatment method, to retort or autoclave treatment, for such sterilization, is a so-called “hot-fill with pasteurization” treatment, which in addition to aseptic filling of a pre-heated and thus partly sterilized food product, maintains the filled and sealed package at an elevated temperature for prolonged heat treatment, such as at a temperature from 80 to 100° C. The maintaining of the package at the elevated temperature is done by forwarding the packages through a heat sterilization tunnel, which is divided into several treatment zones, including a warming-up zone, a heat treatment zone and a cooling zone. The warming-up and heat treatment zones may be treating the packages with dry heat, i.e., with hot air, without steam, or with steam and/or with water that is sprinkled or flushed over the packages. The cooling is normally done by flushing the packages with cooling water. Most commonly, the hot fill pasteurization temperature is regulated (warming up and cooling down) with water.

In the foregoing, the invention has been described on some specific embodiments. However, a skilled person realises that other embodiments and variants are possible within the scope of the following claims.

1. A barrier film for a paper or paperboard-based packaging material, said barrier film comprising:
a microfibrillated cellulose layer, MFC layer, with a first side and a second side, it the MFC layer having a grammage in a range 20-100 g/m², and a density higher than 650 kg/m³;
a PHA, dispersion coated, primer layer coated on at least one side of the MFC layer, wherein the PHA, dispersion coated, primer layer has a coat weight 0.5-12 g/m², the PHA, dispersion coated, primer layer comprising a PHA selected from a group consisting of: PHB, PHBV, PHBH, P, co-polymers of PHB, other homopolymers, and combinations thereof; and
a vacuum deposited layer coated on a first primer layer, the vacuum deposited layer having a thickness of 20 nm, the vacuum deposited layer comprising a material selected from a group consisting of: aluminum, magnesium, silicon, copper, aluminum oxides, magnesium oxides, silicon oxides and combinations thereof.

2. The barrier film according to claim 1, wherein the first side of the MFC layer is coated with the PHA, dispersion coated, primer layer.

3. The barrier film according to claim 1, wherein the first side of the MFC layer is coated with the PHA, dispersion coated, primer layer and the second side of the MFC layer is coated with a second PHA, dispersion coated, primer layer.

4. The barrier film according to claim 1, further comprising:
a PHA coating protective layer on the vacuum deposited layer, the PHA coating protective layer having a coat weight of 0.5 g/m² and comprising a PHA selected from a group consisting of: PHB, PHBV, PHBH, P(3HB4HB), and combinations thereof.

5. The barrier film according to claim 1, wherein the MFC layer has at least one side with a surface roughness, Parker Print-Surf, in a range 0.5-6 μm according to ISO 8791 with a clamp pressure of 1.0 MPa.

6. The barrier film according to claim 1, wherein the PHA, dispersion coated, primer layer has a melting temperature, measured according to ISO 11357-3:2018, in a range 50° C.

7. The barrier film according to claim 1, wherein a solid content of PHA in a dispersion forming the PHA, dispersion coated, primer layer is >20 wt %.

8. The barrier film according to claim 1, wherein the PHA, dispersion coated, primer layer comprises is at least 40% PHA.

9. The barrier film according to claim 1, wherein the MFC layer has a water absorption value lower than 60 g/m².

10. The barrier film according to claim 1, wherein the barrier film has an oxygen transmission rate <10 mL/m²/day at 23° C. and 50% RH according to ASTM F1927-20.

11. The barrier film according to claim 1, wherein the barrier film has an oxygen transmission rate <30 mL/m²/day at 38° C. and 90% RH according to ASTM F1927-20.

12. The barrier film according to claim 1, wherein the barrier film has a water vapor transmission rate of <5 g/m²/day, at 23° C. and 50% RH according to ASTM F-1249-20.

13. The barrier film according to claim 1, wherein the barrier film has a water vapor transmission rate of: <20 g/m²/day, at 38° C. and 90% RH according to ASTM F-1249-20.

14. A paper or paperboard-based packaging material comprising:
a paper or paperboard substrate with a first side, called a print side, and a second side which faces away from the first side;
a PHA adhesive layer coated on the second side of the paper or paperboard substrate; and
the barrier film according to claim 1, wherein the barrier film is attached to the paper or paperboard substrate via the PHA adhesive layer.

15. The paper or paperboard-based packaging material according to claim 14, wherein the first side of the MFC layer faces against the paper or paperboard substrate.

16. The paper or paperboard-based packaging material according to claim 14, wherein the second side of the MFC layer faces against the paper or paperboard substrate-.
